(19) United States
(12) Patent Application Publication
(10) Pub. No.: US 2010/0091440 A1
(43) Pub. Date: Apr. 15, 2010

(54) Implementing Locational Fit Hex Torque Pattern with Low Stress Micro Planes

(75) Inventors: Michael Allen Jones, West Concord, MN (US); Aleksander Miroslaw Mustwillo, Rochester, MN (US)

Correspondence Address: IBM CORPORATION;ROCHESTER IP LAW DEPT 917, 3605 HIGHWAY 52 N, ROCHESTER, MN, 55901-7829, US

(73) Assignee: INTERNATIONAL BUSINESS MACHINES CORPORATION, Armonk, NY (US)

(21) Appl. No.: 12/248,100

(22) Filed: Oct. 9, 2008

(51) Int. Cl. G06F 1/16

(52) U.S. Cl. 361/679.02

(57) ABSTRACT

A bezel assembly apparatus is provided for use with a computer component, such as a direct access storage device (DASD). The bezel assembly apparatus includes a bezel base and a standoff including cooperating bezel base and a standoff mating portions. The cooperating bezel base and standoff mating portions include a cooperating pattern for implementing installation with low force and low stress mating engagement. The cooperating pattern includes a hex torque pattern, providing a locational fit for the standoff, holding the standoff in place during assembly. The hex torque pattern provides six managed stress micro planes that hold the standoff in place during assembly process.

### FIELD OF THE INVENTION

The present invention relates generally to the data processing field, and more particularly, relates to an improved bezel assembly apparatus used with a computer component, such as a direct access storage device (DASD).

### DESCRIPTION OF THE RELATED ART

A need exists for an effective bezel assembly apparatus used with a computer component, such as, a direct access storage device (DASD) or a DASD filler.

A significant problem with conventional bezel assembly apparatus is the failure of a bezel base used with a standoff assembly. Plastic pieces can break off and adversely impact the associated computer component, such as the direct access storage device (DASD) or DASD filler.

Generally high force installation is required for some conventional bezel assembly apparatus. When the bezel base and standoff are assembled together, a high stress results that can cause the bezel base to crack. The torque capability for the cracked bezel base is diminished and the standoff can spin in the bezel base.

### SUMMARY OF THE INVENTION

A principal aspect of the present invention is to provide an improved bezel assembly apparatus used with a computer component, such as a direct access storage device (DASD). Other important aspects of the present invention are to provide such improved bezel assembly apparatus substantially without negative effect and that overcome many of the disadvantages of prior art arrangements.

In brief, an improved bezel assembly apparatus is provided for use with a computer component, such as a direct access storage device (DASD). The bezel assembly apparatus includes a bezel base and a standoff including cooperating bezel base and a standoff mating portions. The cooperating bezel base and standoff mating portions include a cooperating pattern for implementing installation with low force and low stress mating engagement.

In accordance with features of the invention, the cooperating pattern enabling low force and low stress mating engagement includes a hex torque pattern with micro planes. The cooperating pattern provides a locational fit for the standoff, holding the standoff in place during assembly.

In accordance with features of the invention, the hex torque pattern allows the standoff to be retained in the bezel base, providing full torque capability with low possibility of bezel base cracking.

In accordance with features of the invention, the hex torque pattern provides managed stress micro planes that hold the standoff in place during assembly process.

In accordance with features of the invention, the cooperating pattern provides a plurality of reduced stress planes shifting stress down from a critical stress edge, allowing dissipation of the load into the main body of the bezel base.

In accordance with features of the invention, the cooperating pattern implementing low force and low stress mating engagement solves the prior art problem of bezel cracking induced by high hoop stress needed to hold the knurled pattern in the hole and to carry the torque.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is an exploded perspective view not to scale illustrating bezel assembly apparatus in accordance with the preferred embodiment;

FIG. 2 is an enlarged fragmentary perspective view not to scale illustrating bezel assembly apparatus in accordance with the preferred embodiment; and

FIG. 3 is an enlarged fragmentary perspective view not to scale similar to FIG. 2 illustrating prior art bezel assembly apparatus.

### DETAILED DESCRIPTION OF THE PREFERRED EMBODIMENTS

In accordance with features of the invention, an improved bezel assembly apparatus is provided for use with a computer component, such as a direct access storage device (DASD). The bezel assembly apparatus includes a bezel base and a standoff including cooperating bezel base and a standoff mating portions. The cooperating bezel base and a standoff mating portions include a cooperating pattern enabling easy and low force installation and enhanced reliability bezel assembly apparatus.

In accordance with features of the invention, the improved bezel assembly apparatus eliminates high stress press fit, and resolves cracking problems of the prior art. The invention provides a locational fit, stress free, hex torque pattern with managed stress micro planes that hold the standoff in place during the assembly process.

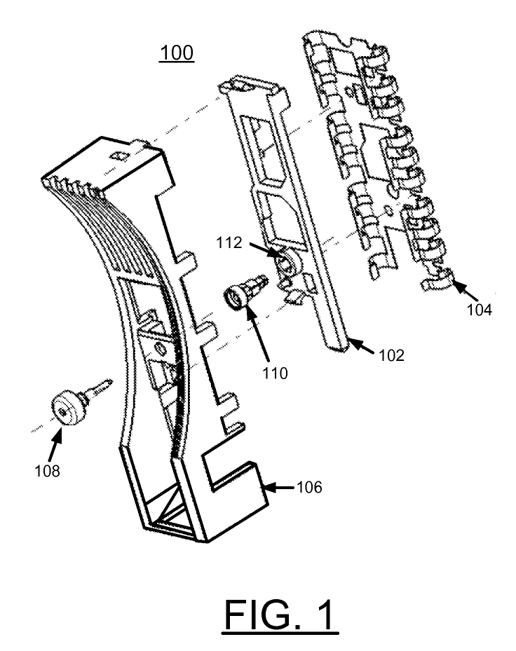

Having reference now to the drawings, in FIG. 1, there is shown a bezel assembly apparatus generally designated by the reference character 100 in accordance with the preferred embodiment. The novel bezel assembly apparatus 100 includes a bezel base 102 of the preferred embodiment, an associated conventional shield member 104, an associated front bezel 106, a conventional plunger 108, and a standoff 110 of the preferred embodiment.

The bezel base 102 and the standoff 110 of the preferred embodiment are assembled together to hold the bezel assembly 100 to an associated component (not shown), such as a DASD drive or DASD filler. The bezel base 102 includes a mating coupling member 112 extending outwardly from the bezel base receiving the standoff 110.

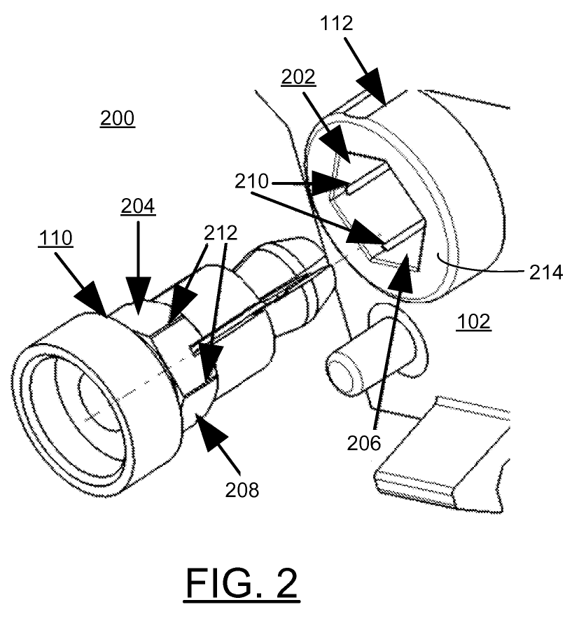

Referring also FIG. 2, there is shown an enlarged fragmentary perspective view not to scale illustrating a bezel base and standoff assembly generally designated by the reference character 200 of the bezel assembly apparatus 100 in accordance with the preferred embodiment. The bezel base and standoff assembly 200 includes the standoff 110 and the mating coupling member 112 that advantageously is integrally formed portion of the bezel base 102.

The bezel base and standoff assembly 200 of the preferred embodiment include a cooperating bezel base portion generally designated by the reference character 202 and a cooperating standoff mating portion generally designated by the reference character 204. The cooperating bezel base and standoff mating portions 202, 204 include a cooperating pattern 206, 208 and a plurality of micro planes 210, 212 for implementing installation with low force and low stress mating engagement.

The cooperating pattern 206, 208 is a hex torque pattern with micro planes 210, 212 enabling low force and low stress mating engagement. The cooperating hex torque pattern 206, 208 provides a locational fit for the standoff 110, to carry the torque during assembly. The cooperating hex torque pattern 206, 208 and micro planes 210, 212 allows the standoff 110 to be retained in the bezel base 102, providing full torque capability with managed stress and low possibility of bezel base cracking.

The cooperating hex torque pattern 206, 208 provides a plurality of respective managed stress micro planes 210, 212 that hold the standoff 110 in place during assembly process.

The plurality of reduced stress planes or micro planes 210, 212 shifting stress down from a critical stress edge 214 of the mating coupling member 112, allowing dissipation of the load into the main body of the bezel base 102.

In accordance with features of the invention, the cooperating pattern 206, 208 implementing low force and low stress mating engagement solves the prior art problem of bezel cracking induced by high hoop stress needed to hold the knurled pattern in the hole and to carry the torque.

The standoff 110 is formed of a metal, such as a carbon steel that is zinc plated. The bezel base 102 including the mating coupling member 112 is formed of an electrically nonconductive material, such as a plastic material, for example, CYCOLOY resin C6850REC material by SABIC Innovative Plastics Europe, which is a ABS+PC (Acrylonitrile Butadiene Styrene+PC) plastic material. The bezel base 102 including the mating coupling member 112 is formed, for example, by injection molding technique.

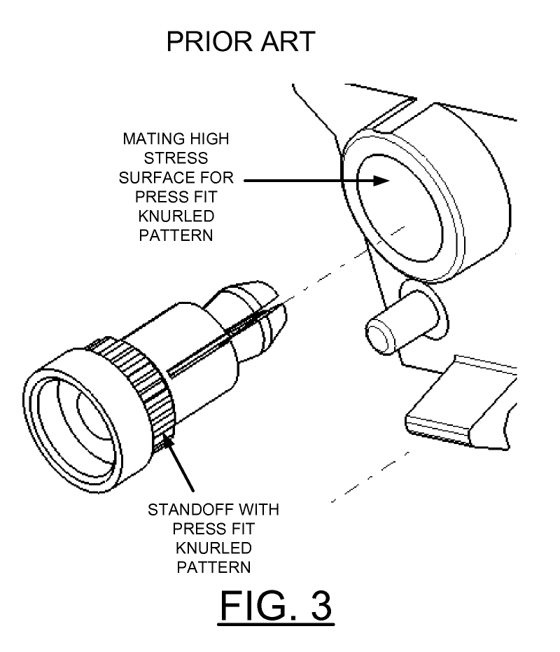

FIG. 3 is an enlarged fragmentary perspective view similar to FIG. 2 illustrating prior art bezel assembly which includes a standoff with a press fit knurled pattern, which is replaced by the mating portion 204 of the standoff 110 of the invention. The prior art press fit knurled pattern is received in press fit engagement with a smooth mating surface of the prior art bezel base, to carry the mounting torque and to hold the standoff in place while it is assembled with the front bezel and DASD. The press fit engagement of prior art press fit knurled pattern requires a substantial installation force. The prior art bezel assembly results in high hoop stress and extremely high occurrence of hairline cracks in the bezel base shortly after it is first assembled.

In brief, the bezel base and standoff assembly 200 of the invention allows for low force installation, standoff retention in the bezel base 102, maintains torque carrying capability, eliminates high hoop stress and hairline cracks when it is assembled with the front bezel 106.

While the present invention has been described with reference to the details of the embodiments of the invention shown in the drawing, these details are not intended to limit the scope of the invention as claimed in the appended claims.

What is claimed is:

1. A bezel assembly apparatus for use with a computer component comprising:
a bezel base; said bezel base including a cooperating bezel base mating portion;
a standoff; said standoff including a cooperating standoff mating portions;
said cooperating bezel base and said standoff mating portions including a cooperating pattern for implementing installation with low force and low stress mating engagement of said standoff with the bezel base.

2. The bezel assembly apparatus as recited in claim 1 wherein said cooperating pattern includes a hex torque pattern.

3. The bezel assembly apparatus as recited in claim 1 wherein said cooperating pattern provides a locational fit for the standoff, holding the standoff in place during assembly with said bezel base.

4. The bezel assembly apparatus as recited in claim 1 wherein said cooperating pattern includes a hex torque pattern, said hex torque pattern retains said standoff in said bezel base, providing full torque capability with low possibility of bezel base cracking.

5. The bezel assembly apparatus as recited in claim 4 wherein said hex torque pattern provides six managed stress micro planes holding said standoff in place during assembly process.

6. The bezel assembly apparatus as recited in claim 1 wherein said cooperating pattern provides a plurality of reduced stress planes.

7. The bezel assembly apparatus as recited in claim 7 wherein said plurality of reduced stress planes enables dissipation of the load from said cooperating bezel base portion into said bezel base.

8. The bezel assembly apparatus as recited in claim 1 wherein said cooperating pattern provides a locational fit of said standoff with said bezel base.

9. The bezel assembly apparatus as recited in claim 1 wherein said standoff is formed of a metal material.

10. The bezel assembly apparatus as recited in claim 1 wherein said bezel base is formed of an electrically nonconductive material.

11. The bezel assembly apparatus as recited in claim 1 wherein said standoff is formed of carbon steel.

12. The bezel assembly apparatus as recited in claim 1 wherein said bezel base is formed of an electrically nonconductive plastic material.

13. A bezel assembly apparatus for use with a computer component comprising:
a bezel base; said bezel base including a cooperating bezel base portion;
a standoff; said standoff including a cooperating standoff mating portions;
said cooperating bezel base and said standoff mating portions including a cooperating pattern for implementing installation with low force and low stress mating engagement of said standoff with the bezel base; said cooperating pattern including a plurality of reduced stress planes, and providing a locational fit for the standoff, holding the standoff in place during assembly with said bezel base.

14. The bezel assembly apparatus as recited in claim 13 wherein said cooperating pattern includes a hex torque pattern.

15. The bezel assembly apparatus as recited in claim 14 wherein said hex torque pattern includes six of said reduced stress planes.

16. The bezel assembly apparatus as recited in claim 13 wherein said plurality of reduced stress planes enables dissipation of the load from said cooperating bezel base portion into said bezel base.

17. The bezel assembly apparatus as recited in claim 13 wherein said standoff is formed of a metal.

18. The bezel assembly apparatus as recited in claim 13 wherein said bezel base is formed of an electrically nonconductive material.

19. The bezel assembly apparatus as recited in claim 13 wherein said bezel and said cooperating bezel base portion are integrally formed.

20. The bezel assembly apparatus as recited in claim 13 wherein said bezel and said cooperating bezel base portion are formed of a plastic material.
